(19) United States
(12) Patent Application Publication
(10) Pub. No.: US 2007/0202303 A1
(43) Pub. Date: Aug. 30, 2007

(54) Method For Producing A Layered Material And A Layered Material

(76) Inventors: Monika Barbara Bischoff, Essen (DE); Alexandra Bruns, Essen (DE); Michael Guth, Duisburg (DE); Constantijn Bernardus Hemel, Essen (DE); Thomas Gerhard Willi Kronke, Velbert (DE); Thomas Thews, Ludenscheid (DE); Detlef Andreas Wentzel, Essen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/557,605

(22) PCT Filed: May 19, 2004
(86) PCT No.: PCT/EP04/05378

§ 371 Date: Feb. 20, 2007

Related U.S. Application Data
(60) Provisional application No. 60/472,783, filed on May 23, 2003.

(30) Foreign Application Priority Data
May 23, 2003 (EP) 03445063.5

(51) Int. Cl. B41M 5/00; B32B 5/16

(52) U.S. Cl. 428/195.1; 428/323

(57) ABSTRACT

A method is provided for producing a layered material. This method includes the steps of impregnating a substrate with a thermosetting resin and further impregnating or coating the so impregnated substrate with a dispersion comprising thermally expandable microspheres.

The present invention relates to a layered material and a method for producing a layered material and claims priority of the European patent application 03 445 063.5-2124 and the U.S. patent application No. 60/472,783 which are hereby fully incorporated in terms of disclosure.

Hard surfaces of flooring materials such as wooden flooring or laminate flooring materials are known to generate disturbing noise when walked upon. Depending on the structure of the flooring material, the generation and transmission of sound varies. For example, laminated flooring materials usually have a carrying layer of a Medium Density Fibre Board, which usually gives considerable more noise problems than a solid wood layer. However, also flooring materials such as parquet flooring, which usually consists of only solid wood layers, may give noise problems, especially when floating instead of being glued to the ground completely.

A typical decorative laminate for flooring comprises layers of resin impregnated papers attached onto a carrying layer of a rigid material. The upper layers comprise a decorative sheet and usually also an overlay and one or more resin impregnated paper layers under the decorative sheet. Onto the underside of the carrying layer is usually attached a balancing backing layer comprising a resin-impregnated paper to prevent warping of the laminate. A decorative laminate is usually manufactured by assembling the layers constituting the laminate and pressing the assembly under heat so that the resin in impregnated layers cures, forming a uniform laminate.

A parquet flooring material usually comprises a carrying layer of low quality wood or plywood, a surface layer of high quality wood and a backing veneer of low quality wood.

Several attempts have been made to reduce noise generated when walking on flooring materials:

WO 02/47906 A1 discloses a decorative laminate where a foil of an elastomer is arranged on the upper side of a carrying core.

EP 1 247 923 A1 and WO 01/09461 A1 disclose a floor covering with sound-proofing properties having an underside of a thermoplastic material. However, in EP 1 247 923 A1 and WO 01/09461 A1, an extra step is needed in the production process when the thermoplastic layer is applied onto an already attached backing layer of a laminated flooring material.

WO 01/45940 relates to an abrasion-resistant decor sheet comprising a protective overlay containing expanded thermoplastic microspheres. However, the problem with sound transmission is not discussed at all.

Thus, there is a need of a flooring material with good sound damping properties, which can be produced in a simple way by small adaptations of the production methods already used.

### THE INVENTION

According to the invention it has surprisingly been found possible to achieve the above mentioned objectives by providing a layered material, which comprises a substrate which is impregnated with a thermosetting resin and is further coated with expanded microspheres embedded in a dispersed phase. The continuous phase of the dispersion preferably contains thermoplastic polymers.

In one aspect the invention further pertains to a method for producing a layered material, preferably a flooring material. Thus according to one embodiment of the invention the layered material is attached to a further layer. Thereafter the microspheres are expanded.

Suitably, the layered material obtainable by the method according to the invention comprises an upper side and an underside. In relation to the carrying layer the upper side suitably being the side either comprising a decorative layer or intended to accept a layer of a material, which is visible to the end-user of the layered material, such as paint or wall paper. Preferably, the layered material comprises an upper decorative layer. The layer comprising thermally expandable microspheres is suitably positioned under the carrying layer.

In one preferred embodiment of the invention, the method suitably comprises bringing together the layer (substrate) comprising thermally expandable microspheres with another layer of the layered material, thereby forming an assembly, pressing and heating the assembly above the temperature at which the microspheres starts to expand at atmospheric pressure and releasing the pressure from the assembly, whereupon the microspheres expand. The main expansion of the microspheres suitably takes place directly when the pressure has been relieved.

In another preferred embodiment of the invention the method comprises the steps of: joining the layer comprising thermally expandable microspheres onto another layer of the layered material, followed by heating the layer comprising thermally expandable microspheres above the temperature at which the microspheres starts to expand without substantial pressing.

The method according to the main aspect of the invention comprises the steps of impregnating or coating a substrate impregnated with a thermosetting with a composition comprising thermally expandable microspheres, thereby forming a layer comprising thermally expandable microspheres dispersed in a continues polymer phase on top of a layer impregnated with a thermosetting.

The layer comprising thermally expandable microspheres is suitably positioned 0 to 5 layers deep into the layered product, preferably 0 to 2 layers. Most preferably, the layer comprising thermally expandable microspheres is an outermost layer of the layered material.

The layered material is suitably a flooring material. Examples of suitable flooring materials are: a decorative laminate flooring material, a parquet flooring material, and resilient flooring materials such as vinyl floorings. Preferably, the flooring material is a decorative laminate flooring material. Alternatively, the flooring material is preferably a parquet flooring material.

The layered material can also suitably be a wall- or roofing element.

The layer comprising thermally expandable microspheres suitably comprises a paper.

The present invention further comprises a layered material comprising two or more layers of which one is a carrying layer. The layered material comprises an upper side and an underside, in relation to the carrying layer, the upper side being the side either comprising a decorative layer or intended to accept a layer of material, which is visible to the end-user of the layered material, such as paint or wall paper. Preferably, the layered material comprises an upper decorative layer. The at least one layer comprising thermally expandable microspheres is positioned under the carrying layer. Suitably, an outermost layer of the layered material comprises expanded thermoplastic microspheres.

The layer comprising expanded thermoplastic microspheres is suitably positioned 0 to 5 layers deep into the layered product, preferably 0 to 2 layers. Most preferably, the layer comprising expanded thermoplastic microspheres is an outermost layer of the layered material. Suitably, the layer of the layered material comprising expanded thermoplastic microspheres further comprises a polymer phase apart from the thermoplastic microspheres. Preferably, the polymer phase comprises a polyurethane.

Suitably, the layered material is a flooring material. Suitably, the flooring material comprises an upper decorative layer, a carrying layer and a backing layer. Preferably, the layered material is a decorative laminate flooring material. Suitably, the backing layer comprises expanded thermoplastic microspheres. Alternatively, the flooring material suitably comprises a surface layer, a carrying layer, a backing veneer and a backing layer. Preferably, the flooring material is a parquet flooring material. Suitably, the backing layer comprises expanded thermoplastic microspheres. The layered material can also suitably be a wall- or roofing element.

The thermally expandable microspheres are preferably dispersed in a thermoplastic polymer having a glass transition temperature of from about −100 to about +10° C., preferably from about −80 to about −20° C. Examples of suitable polymer dispersions are a polyurethane dispersion, a polyacrylate dispersion, a polyester dispersion a PVC dispersion, and a plastisol dispersion. Preferably, the polymer dispersion is a polyurethane dispersion.

The amount of thermally expandable microspheres in the dispersion may vary within broad limits, depending on the desired properties of the finished product, and is suitably from about 1 to about 80 weight %, preferably from about 5 to about 25 weight %. The ratio thermally expandable microspheres to dispersed polymer in the treating composition, calculated as dry matter, is suitably from about 1:1 to about 1:10, preferably from about 1:3 to about 1:7.

Finally, the present invention relates to the use of an impregnated or coated substrate as a part of a layered material, especially as a balancing backing layer.

The layer comprising thermally expandable microspheres according to the method of the invention may comprise any type of impregnable substrate, including paper and woven and non-woven textiles. Suitably, the layer comprising thermally expandable microspheres comprises a paper. Suitably, the paper has a weight of from about 20 to about 250 g/m², preferably from about 50 to about 140 g/m². The paper is suitably a kraft paper/regenerated paper.

The substrate is suitably impregnated with one or more curable resins. Suitable curable resins for impregnating the substrate according to the present invention are thermosetting resins, such as melamine resins, for example, melamine-formaldehyde, urea resins, for example, urea-formaldehyde, phenolic resins, for example, phenol-formaldehyde, or mixtures thereof. Preferably, a melamine-formaldehyde resin is used for impregnating the backing layer. The substrate is suitably impregnated with an amount of from about 40 to about 300 g/m² of a curable resin, preferably from about 80 to about 150 g/m².

The substrate can be impregnated with one or more curable resins by various conventional techniques of applying resin compositions, such as baths, rollers, doctor blades, air knife, metering roll, doctor bars, etc. The resin compositions can be applied in one or more steps with drying and/or partial curing between the application stages.

The impregnation, or coating, of the substrate with thermally expandable microspheres suitably takes place after the impregnation with the one or more resin compositions. Suitably, the impregnation, or coating, of the substrate with thermally expandable microspheres takes place by coating or impregnating the substrate with a treating composition comprising thermally expandable microspheres.

Thermally expandable microspheres suitable for use in the present invention have a thermoplastic polymer shell enclosing a propellant. The thermoplastic polymer shell may consist of a copolymer of monomers selected from the group: acrylonitrile, methacrylonitrile, alpha-ethoxyacrylonitrile, alpha-chloroacrylonitrile, fumaronitrile, vinylidene chloride, vinyl chloride, methacrylic ester, acrylic ester, styrene, vinyl acetate, butadiene, neoprene and mixtures thereof. The thermoplastic microspheres may be produced in conventional fashion, for instance as set forth in U.S. Pat. No. 3,615,972, which hereby is incorporated by reference. The propellant is normally a liquid having a boiling temperature not higher than the softening temperature of the thermoplastic polymer shell. The propellant, also called the blowing agent, expanding agent or foaming agent, can be hydrocarbons such as n-pentane, isopentane, neopentane, butane, isobutane, hexane, isohexane, neohexane, heptane, isoheptane, octane and isooctane, or mixtures thereof. Aside from them, other hydrocarbon types can also be used, such as petroleum ether, and chlorinated or fluorinated hydrocarbons, such as methyl chloride, methylene chloride, dichloroethane, dichloroethylene, trichloroethane, trichloroethylene, trichlorofluoromethane etc. The propellant suitably makes up 5-40 weight % of the microsphere. Upon heating, the propellant evaporates to increase the internal pressure at the same time as the shell softens, resulting in significant expansion of the microspheres, normally from about 2 to about 5 times their diameter. The temperature at which the expansion starts is called Tₛₜₐᵣₜ, while the temperature at which maximum expansion is reached is called Tₘₐₓ, both determined at a temperature increase rate of 20° C. per minute. The thermally expandable microspheres used in the present invention suitably have Tₛₜₐᵣₜ within the range of from about 40 to about 200° C., preferably from about 50 to about 150° C., most preferably from about 70 to about 130° C., while Tₘₐₓ suitably is within the range of from about 60 to about 250° C., preferably from about 80 to about 210° C., most preferably from about 100 to about 200° C. The particle size of the expandable microspheres may vary within broad limits and is chosen with respect to the properties desired for the finished product. Suitable examples of particles sizes for the expandable microspheres could be 1 to 1000 μm, preferably 2 to 500 μm and most preferably 5 to 50 μm.

The carrying layer according to the present invention is suitably rigid, and can be made of any suitable material such as a wood based material or a polymer based material. Suitably, the carrying layer is made of a wood based material such as solid wood, plywood, particleboard, fibreboard, and chipboard. Preferably, the carrying layer is made of a particle- or fibreboard.

The laminate is suitably pressed at a temperature of from about 100 to about 250° C., preferably from about 125 to about 200° C., at a pressure of from about 0.1 to about 10 MPa, preferably from about 2 to about 4 MPa.

In a preferred embodiment of the present invention, a kraft paper/regenerated paper is impregnated with a melamine resin in a first step, dried and subsequently impregnated with a slurry comprising from about 5 to about 25 weight % thermally expandable microspheres, and a dispersion of polyurethane wherein the ratio thermally expandable microspheres to dispersed polymer in the slurry, calculated as dry matter is from about 1:3 to about 1:7. Thereafter, the impregnated paper is dried and assembled and pressed at a pressure between about 2 and about 4 MPa, onto a carrying layer of MDF. After release of the pressure the microspheres expand and form a smooth layer.

The invention will now further be described in connection with the following example which, however, not should be interpreted as limiting the scope of the invention

### EXAMPLE 1

A regenerated paper (120 g/m² weight per unit area) was used as a substrate and was impregnated applying a standard method (i.e. filling of the paper matrix with melamine resin and coating of the paper). The impregnated paper was then dried in a floating web drier to a residual content of 6.5% volatile substances. The final weight of the impregnated and coated regenerated paper was 250 g/m².

Within the same machine run the paper was coated on one side with an aqueous, heterogeneous and stable mixture containing 10% (by weight) of non-expanded microspheres (particle size: 28-38 μm), T start=116-126° C., T-max=190-202° C., and 90% or 78% (by weight) of an aqueous dispersion of polyurethane (solid content=40% by weight) and dried. The glass transition temperature (TG) of the polyurethane dispersion was −32° C. The final weight of the so impregnated and coated paper was 330 g/m² with a residual content of volatile substances of 6.5%.

For manufacturing a decorative laminate a 8 mm Medium Density Fibre Board (MDF) was assembled topside with a decorative layer (melamine resin impregnated, printed decorative paper; final weight 250 g/m^{2.}, paper weight 120 g/m²) and underside with the impregnated paper as described above. The assembly was pressed at 160° C. at a pressure of 2.0 MPa for 30 seconds.

At heat stripping from the coated MDF the microspheres on the backside expand. Embedded within the matrix of polyurethane the expanded microspheres provide for a sound proofing layer with closed pores, which is deeply and strongly connected and bound to the melamine resin (according to the cross-cut-test).

As surveyed according to the method of example 5 the laminate provided herewith had sound proofing properties resulting in 12 sone units without showing any deterioration of the balancing properties of the backing paper. The laminate did not show any significant warping within the examined period of 4 weeks.

### EXAMPLE 2

A natron kraft paper (80 g/m² weight per unit area) was used as the carrying layer and was impregnated according to a standard method with a commercially available melamine resin and then dried in a floating web drier to a residual content of 7.0% volatile substances. The final weight of the impregnated and coated kraft paper was 200 g/m².

During the same procedural step the paper was coated on one side with an aqueous, heterogeneous and stable mixture containing 15% (by weight) of non-expanded microspheres (particle size: 35-45 μm), T start=112-120° C., T-max=180-188° C., and 85% (by weight) of an aqueous dispersion of polyurethane (solid content=45% by weight) and dried. The glass transition temperature (TG) of the polyurethane dispersion was −55° C. The final weight of the so impregnated and coated paper was 275 g/m² with a residual content of volatile substances of 6.9%.

According to the method outlined in example 1 a decorative laminate was manufactured using a decorative paper with final weight of 200 g/m² (paper weight 80 g/m²).

At heat stripping from the coated MDF the microspheres on the backside expand. Embedded within the matrix of polyurethane the expanded microspheres provide for a sound proofing layer with closed pores, which is deeply and strongly connected and bound to the melamine resin (according to the cross-cut-test).

The flatness of the laminate remains unchanged during the 4 week examination period. The balancing properties of the backing layer were not negatively influenced by applying the sound damping layer. The sound proofing properties, i.e. the sound reduction measured according to example 5, were 8 sone units.

### EXAMPLE 3

A regenerated paper (120 g/m² weight per unit area) was impregnated with a standard melamine resin as outlined in example 1 and then dried in a floating web drier to a residual content of 6.2% volatile substances. The final weight of the impregnate was 260 g/m².

During the same procedural step the impregnate was coated on one side with an aqueous, heterogeneous and stable mixture containing 8% (by weight) of non-expanded microspheres (particle size: 18-24 μm), T start=116-124° C., T-max=171-181° C., and 92% (weight/weight) of a 50% aqueous anionic dispersion of a butadiene-styrene co-polymer (TG=−66° C.). The final weight of the so impregnated paper was 340 g/m² with a residual content of volatile substances of 6.1%.

According to the method outlined in example 1 a decorative laminate was manufactured using a decorative paper with final weight of 255 g/m² (paper weight 120 g/m²).

At heat stripping from the coated MDF the microspheres on the backside expand. Embedded within the butadiene-styrene co-polymer the expanded microspheres provide for a sound proofing layer with closed pores, which is deeply and strongly connected and bound to the melamine resin (according to the cross-cut-test).

The flatness of the laminate remains unchanged during a 6 week examination period. The balancing properties of the backing layer were not negatively influenced by applying the sound damping layer. The sound proofing properties, i.e. the sound reduction measured according to example 5, were 10 sone units.

### EXAMPLE 4

According to example 1 a regenerated paper (120 g/m² weight per unit area) was impregnated with a standard melamine resin and dried to a residual content of 6.8% volatile substances. The final weight of the impregnated paper was 255 g/m².

During the same procedural step the impregnate was coated on one side with an aqueous, heterogeneous and stable mixture containing 10% (by weight) of non-expanded microspheres (particle size: 28-38 μm), T start=116-126° C., T-max=190-202° C., and 90% (by weight) of a 42% aqueous paste of poly vinyl chloride (PVC) (TG=−15° C.). The final weight of the so impregnated paper was 335 g/m² with a residual content of volatile substances of 6.6%.

According to the method outlined in example 1 a decorative laminate was manufactured using a decorative paper with final weight of 250 g/m² (paper weight 120 g/m²).

At heat stripping from the coated MDF the microspheres on the backside expand. Embedded within the PCV the expanded microspheres provide for a homogenous sound proofing layer with closed pores.

The flatness of the laminate remains unchanged during 4 week examination period. The balancing properties of the backing layer were not negatively influenced by applying the sound damping layer. The sound proofing properties, i.e. the sound reduction measured according to example 5, were 2 sone units.

### EXAMPLE 5

For evaluating the sound proofing properties of the laminates manufactured according to the invention the laminates were examined according to the draft EPLF (European Producers of Laminate Flooring) norm 021029-1 “Laminate floor coverings−determination of drum sound generated by means of a tapping machine” (from Oct. 29, 2002, revision status November 2003). The draft norm is obtainable from EPLF.

According to this draft norm an excitation is provided by using a standard tapping machine. The stationary measurements in the acoustic environment is similar to a free-field room. The signals are evaluated for specific loudness and overall loudness according to ISO 532B.

The dimension for the specific loudness is “Sone”. Sone reduction values between 0 and 15 sone units are considered as being relevant for sound damping.

1. A method for producing a decorative laminate comprising a carrying layer comprising the following steps:
impregnating a substrate with a thermosetting resin and further impregnating or coating the so impregnated substrate with a dispersion comprising thermally expandable microspheres, thereby forming a layered material;
assembling the laminate by positioning the layered material comprising thermally expandable microspheres under a carrying layer and by positioning a decorative layer impregnated with a thermosetting resin on top of the carrying layer.

2. A method according to claim 1 wherein the decorative layer is impregnated with a melamine resin.

3. A method according to claim 1, wherein the layered material comprising thermally expandable microspheres forms the outermost layer on the underside of the decorative laminate.

4. A method according to claim 1, wherein the method further comprises expanding the microspheres.

5. A method according to claim 1, further comprising:
heating at least the layered material comprising thermally expandable microspheres, without pressing, above the temperature at which the microspheres start to expand.

6. A method according to claim 1, wherein the layered material comprising thermally expandable microspheres further comprises a paper.

7. A method according to claim 1, wherein the laminate is a decorative flooring material.

8. A method according to claim 1, wherein the laminate is a parquet flooring material.

9. A method according to claim 1, wherein the thermally expandable microspheres are dispersed in a thermoplastic polymer.

10. A method according to claim 9, wherein the thermoplastic polymer has a glass transition temperature from about −100° C. to about +10° C.

11. A material comprising a carrying layer, a decorative layer and a layered material;
wherein the layered material comprises a substrate that has been impregnated with a thermosetting resin and has been further impregnated or coated with a dispersion comprising expandable microspheres; and
wherein said layered material is positioned under the carrying layer and the decorative layer is positioned on top of the carrying layer.

12. A layered material according to claim 11 wherein the microspheres are dispersed within a thermoplastic polymer.

13. A layered material according to claim 12, wherein the thermoplastic polymer has a glass transition temperature from about −100° C. to about +10° C.

14. A layered flooring material obtainable by a method comprising:
impregnating a substrate with a thermosetting resin;
further coating or impregnating the so impregnated substrate with thermally expandable microspheres; and
assembling the layered flooring material by positioning the so impregnated substrate on top of a carrying layer, and by positioning a decorative layer impregnated with a thermosetting resin, under the carrying layer.

15. A layered flooring material according to claim 14, wherein the thermally expandable microspheres are dispersed in a continuous phase comprising a thermoplastic polymer.

16. A layered flooring material according to claim 14, wherein the method for obtaining the layered flooring material further comprises heating under pressure.

17. A layered material according to claim 11, wherein the dispersion comprises a polyurethane.

18. A layered material according to claim 11, wherein the substrate comprises a paper.

19. A method according to claim 10, wherein the thermoplastic polymer has a glass transition temperature from about −80° C. to about −20° C.

20. A method according to claim 13, wherein the thermoplastic polymer has a glass transition temperature from about −80° C. to about −20° C.

21. A layered flooring material according to claim 15, wherein the thermoplastic polymer has a glass transition temperature from about −100° C. to about +10° C.

22. A layered flooring material according to claim 21, wherein the thermoplastic polymer has a glass transition temperature from about −80° C. to about −20° C.
